(19) United States
(12) Patent Application Publication
(10) Pub. No.: US 2015/0045013 A1
(43) Pub. Date: Feb. 12, 2015

(54) MULTI-LEVEL VEHICLE REMOTE START AUTHENTICATION METHOD & SYSTEM

(71) Applicant: Directed, LLC, Vista, CA (US)

(72) Inventor: Michael S. Simmons, Aliso Viejo, CA (US)

(73) Assignee: Directed, LLC, Vista, CA (US)

(21) Appl. No.: 14/450,064

(22) Filed: Aug. 1, 2014

Related U.S. Application Data
(60) Provisional application No. 61/864,425, filed on Aug. 9, 2013.

(51) Int. Cl. H04W 4/00; G07C 5/00; H04L 29/08; H04W 12/04

(52) U.S. Cl. CPC H04W 4/008; H04W 12/04; G07C 5/008; H04L 67/12
USPC 455/420

(57) ABSTRACT

A method for providing secured vehicle remote function control signals to a vehicle using a smart phone. The method provides communicating secured pairing and command signal transmissions to a vehicle remote convenience system. The method allows for the use of a smart phone to replace the factory remote fob for remotely starting the vehicle and controlling the vehicle ignition and locking systems through generating local radio frequency transmission and signal encryption that are transmitted to and authenticated at an in-vehicle transceiver.

### CROSS-REFERENCE TO RELATED APPLICATIONS

This application claims the benefit of U.S. States Provisional Patent Application Ser. No. 61/864,425 filed Aug. 9, 2014 entitled MULTI-LEVEL VEHICLE REMOTE START AUTHENTICATION METHOD & SYSTEM.

### BACKGROUND OF THE INVENTION

1. Field of the Invention

This invention relates to methods and systems for authentication of authorized signals for remote operation of vehicle functions. The method and system employs wireless transmission of encrypted signals a multiple levels when transmitting commands for operation and control of a vehicle. More importantly, this invention discloses a novel way by which one can remotely operate a vehicle using a smart phone without compromising the vehicle's passive anti theft security system.

2. Description of the Prior Art

The ability to remotely start or operate certain functions of a vehicle using a smart phone has been found to be highly desirable. Smart phones have become ubiquitous and consolidate into a single device many function previously performed by multiple devices carried by a user. Vehicle remote start and security systems using handheld fobs for remotely transmitting commands are known and have been used to remotely activate system functions. Handheld fobs with encrypted and rolling code RF signals have been used as preferred secure communication link With the proliferation of smart phones, consumers now prefer to eliminate fobs in favor of controlling vehicle functions with a smart phone.

Smart phones allow for user applications as a convenient interface to provide for the remote control of vehicle functions. These graphical user interfaces provide for simple and intuitive use. In order for a smart phone to provide a command signal to the vehicle to remotely control the vehicle, the smart phone must either have a local RF capability such as Bluetooth® or the vehicle must have a cell phone transceiver installed in the vehicle and interfaced with vehicle electronics. Use of cellular network to send command to the vehicle are well known, however a number of limitation arise. Using a cell network to send commands requires an in-vehicle cell phone transceiver and a second cell network service provider account, which requires a monthly fee increasing the cost for use of the system. Cell phone transceivers are generally very secure and have personal identification numbers (PIN) associated with each phone and service provider network account. Generally, a PIN provides adequate security with respect to the communication link to the vehicle over long distances through the cell phone network.

For local RF links using a smart phone, Bluetooth® is generally used for providing command signals to vehicles (see U.S. Pat. No. 7,257,426, which is fully incorporated herein by reference with each of its related applications). Bluetooth® allows for the transmission of a device identification signals that can be received by other local Bluetooth® enabled devices. However, in some circumstances, while in pairing mode, a device may pair with an unintended or unauthorized Bluetooth transceiver that is in proximity

If the receiving device is in discovery mode it will paired with the transmitting device. If both devices have previously been paired, the device is presumed authorized, a local RF communication link between the devices is automatically established, and data is automatically transfer between the paired devices. However, if during pairing and unauthorized devices is within range and in pairing mode, the devices will be paired, even if it was not intended that the device be authorized. Therefore a need exists for communication link verification between devices for remotely controlling vehicle functions.

### SUMMARY OF THE INVENTION

In view of the this background, disclosed is a method for providing secured vehicle remote start signals to a vehicle using a smart phone. It is a primary objective of the invention to provide for a method of communicating a secured pairing and command signal transmission to a vehicle remote convenience system. The method allows for the use of a smart phone to replace the factory remote fob for remotely starting the vehicle and controlling the vehicle ignition and locking systems. It is a further object of the invention to provide a method of remotely operating selected vehicle functions using a smart phone through generating local radio frequency transmission and signal encryption that are transmitted to an in-vehicle transceiver for authentication. . To avoid unauthorized pairing and to provide for secure command signal transmission, an identification code may be processed with an additional layer of encryption prior to transmission by the phone with an encryption decryption key on cell phone application, thus providing an additional layer of security. The encrypted communication is then decrypted with a encryption decryption key by the controller at the module. This prevents unauthorized vehicle access by paring of a short range radio device that may be in proximity at the time when an authorized device is paired. Only the authorized device has the proper encryption with the in-vehicle transceiver.

### BRIEF DESCRIPTION OF THE DRAWING

FIG. 1 is a schematic illustration showing one embodiment of a system that carries out the inventive method.

FIG. 2 is a schematic illustration showing the coil associated with the module.

### DESCRIPTION OF THE INVENTION

The present invention is a method that enables authentication of a wirelessly transmitted pairing and command signal for control of a remote vehicle starter or security system using a short range RF enabled smart phone paired with an enabled transceiver module installed in a vehicle. The method provides establishing an authorized communication link and for encryption of a command signal to an authorize remote function control system. Example embodiments are described herein in the context of a method for authenticating command signals for remote vehicle function systems. Those of ordinary skill in the art will realize that the following description is illustrative only and is not intended to be in any way limiting. Other embodiments will readily suggest themselves to such skilled persons having the benefit of this disclosure.

Reference will now be made in detail to implementations of the example embodiment as illustrated in the accompanying drawings. The same reference indicators will be used throughout the drawings and the following description to refer to the same or like items.

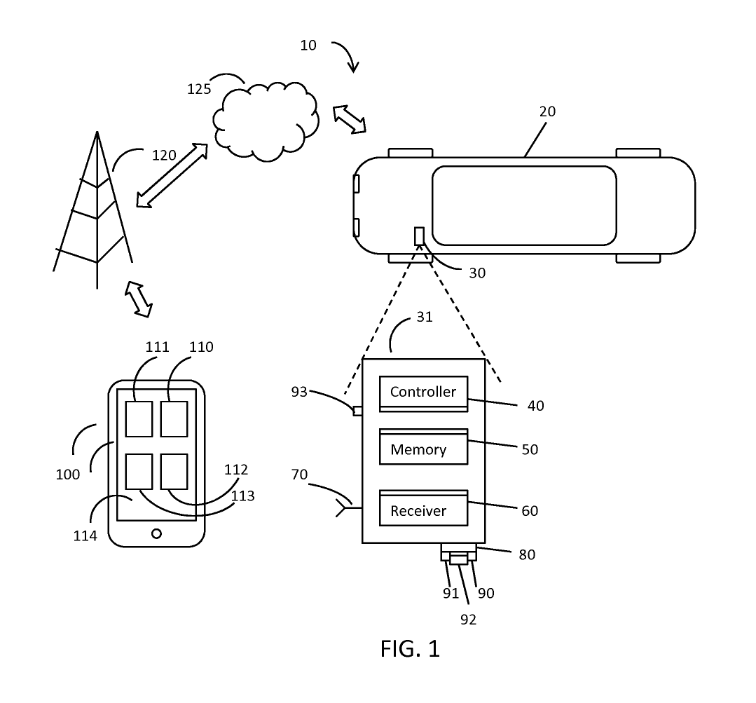

Now with reference to the Figures, FIG. 1 shows one embodiment of a system 10 for implementation of the novel method. Installed within a vehicle 20 is a module 30. In FIG. 1, the module 30 is shown in a larger view outside the vehicle 31. The enabled module 31 may be fully incorporated or integrated into the design of an aftermarket remote starter, keyless entry or security system module, or it can be stand alone. If stand alone, connection with the remote starter, keyless entry or security system is through an electronic connector such as a multi-pin connector 80 having a power 90, ground 91, and data communication line 92.

The module 31 is comprised of a receiver 60, which may be in the form of a transceiver, a micro controller 40, a memory 50, a power circuit 90, and a data line 92. The module 31 is further comprised of a power management circuit (not shown) and the system components are powered by connection of the module to the vehicle's 20 power circuit and ground. As will be appreciated by one skilled in the art, the module 31 is electrically connected to the remote start or security system and vehicle electrical system through known installation processes and connections. In some embodiments the system may include an analog-to-digital converter (not shown) for converting analog electrical pulses into digital signals.

The module memory 50 stores executable code and is associated with a microcontroller 40 which executes the code and directs the various functions of the module 31, including communicating command signals to the vehicle's 20 electrical system. The executable code provides for a paring mode and an operating mode. Pairing mode is entered by depression of a switch 93 on the module. Other methods include a change in the voltage at the time of initial installation or a grounding sequence. To prevent unintended entry of the pairing mode a pre-determined sequence of switch depressions may be required. When in the pairing mode, the module receiver 60 accepts transmissions from a compatible smart phone 100, having an installed application that can be downloaded from the internet or otherwise uploaded to the smart phone 100.

The application is computer executable code that operates as a graphical user interface for the system. The graphical user interface will allow selection of various application modes of the system by capacitance touch of icons 110, 111, 112 and 113 on the LCD screen 114 of the smart phone. Icons 110, 111, 112 and 113 represent various functions of the system. The application may provide for multiple vehicles under the same smart phone by creating separate vehicle records that can be represented as a separate icon for each vehicle.

Pairing is accomplished by transmitting a pairing message from the smart phone 100 while the in-vehicle module 31 is in pairing mode. Upon confirmation of the initial pairing handshake, the smart phone

ID signal is encrypted within the phone app, transmitted from the smart phone 100, received at the module receiver 60, where it is decrypted in the associated controller 40 and stored in the module memory 50. By performing this encryption decryption process, an unauthorized smart phone transmitting a signal within proximity of the module 30 during the pairing procedure cannot be unintentionally or fraudulently stored in memory and thus gain unauthorized access to the vehicle.

In one embodiment the Bluetooth® signal transmission standard provides for a pairing mode that allows the smart phone 100 and in-vehicle module 31 to be authorized for communications using the identification codes assigned to each of the specified Bluetooth® transceivers. When in range after pairing, the paired transceivers recognize each other, based on the transceiver identification code, and allow relatively secured communications between the paired devices. In the context of the current invention, prior to transmission or establishing a pairing the Bluetooth ID is encrypted with an encryption key. The in-vehicle module 31 must have the corresponding encryption key to decode the ID prior to storage in memory.

In another embodiment the in-vehicle module 30 may have stored in memory 50 a plurality of encryption keys. At the time of pairing, the phone app will randomly select one encryption key from the plurality of encryption keys stored and transmit instructions to the in-vehicle module to select the corresponding decryption key. Once selected, the smart phone 100 and in-vehicle module 30 will continue to use the same encryption/decryption keys to validate signal authorization. This adds an additionally layer of security to the pairing process.

The module 31 may also provide a means for communicating ignition key transponder signals associated with the passive anti theft system to the vehicle during remote starting when the key is not in proximity of the ignition switch. In one embodiment, the key transponder code is emulated by the module 31. Emulation is accomplished by placing the original vehicle key in the ignition switch and starting the vehicle. The module incorporates a coil or other wireless RF receiver associated with the controller. The coil is placed near the ignition switch. When, during the normal ignition start sequence, the transponder is placed near the ignition and signal sequences are transmitted by ignition coil and the key transponder, the module coil or other receiving means receives the signals and stores it in the module memory. During subsequent remote start events, when the ignition key is not present, the controller retrieves the transponder code from memory 50 and module transceiver generates the transmission of the transponder code to the coil, communicating the transponder code to the vehicle through the coil and emulating the original ignition key transponder code.

In another embodiment, the module may incorporated a separate second transponder that is programmed or recorded into the passive anti theft system control module key recognition system as an authorized key, similar to programming an original key transponder at the factory. The vehicle is put into a programming mode through well known processes, such as ignition switch turns, door pin and brake pedal depressions sequences. While in programming mode, the module transponder is placed in proximity to the vehicles ignition switch coil, either directly or by placing a second coil near the switch coil. The transponder identification code is transferred to the vehicle and stored in the vehicle's passive anti theft system memory as an authorized key. When the module receives a remote start command signal from the smart phone or the remote start system, the module provides the transponder code that has been programmed and the vehicle recognizes the code as authorized.

It will be appreciated by one skilled in the art that the module may be designed to incorporated any combination of the above described passive anti theft system bypass methods to provide an authorized transponder code, including placement of the coil in the smart phone or interfacing with the smart phone through a connector and learning the code to the smart phone app and transmitting the code to the remote start system with the remote start command signal.

Generally, an analog-to-digital converter is not required for execution of the current invention. In those embodiments where the module is connected to a analog based stand alone remote start, keyless entry or security system an analog-to-digital converter may be employed to convert pulsed electrical analog signals generated by the aftermarket remote start or security system into digital command signals matching the factory command signals and recognized by the vehicle data bus network. In such an embodiment, the remote starter or security system employs a microcontroller to operate the functions of the device. To provide additional security a second layer of encryption of remote starter command data is executed. The module 31, after receiving encrypted data from the smart phone 100, will decrypt the data with a key associated with received data, and then using a second encryption algorithm, encrypt the command signal for transmission to the analog-to-digital converter. The analog-to-digital converter decrypts the transmission and converts them to original OEM signals that provide operational control of the vehicle. This is especially helpful in preventing unwanted interception or access to transponder code that may be transmitted with a command code. This second layer also prevents unauthorized access by simply mimicking the analog signal provided to the converter.

Communication links to the vehicle can be made from the smart phone both locally through radio frequency signals and over longer distances through communication with the vehicle through a cell phone network, represented in FIG. 1 with the cell phone tower 120 in communication with the back end wireless computer network sometimes referred to as the cloud 125. It is contemplated that messages communicated through the cell phone network 120 can also be encrypted and decrypted as described. The transmission simply routes through the cell network 120 rather than directly through the local transmitter receiver.

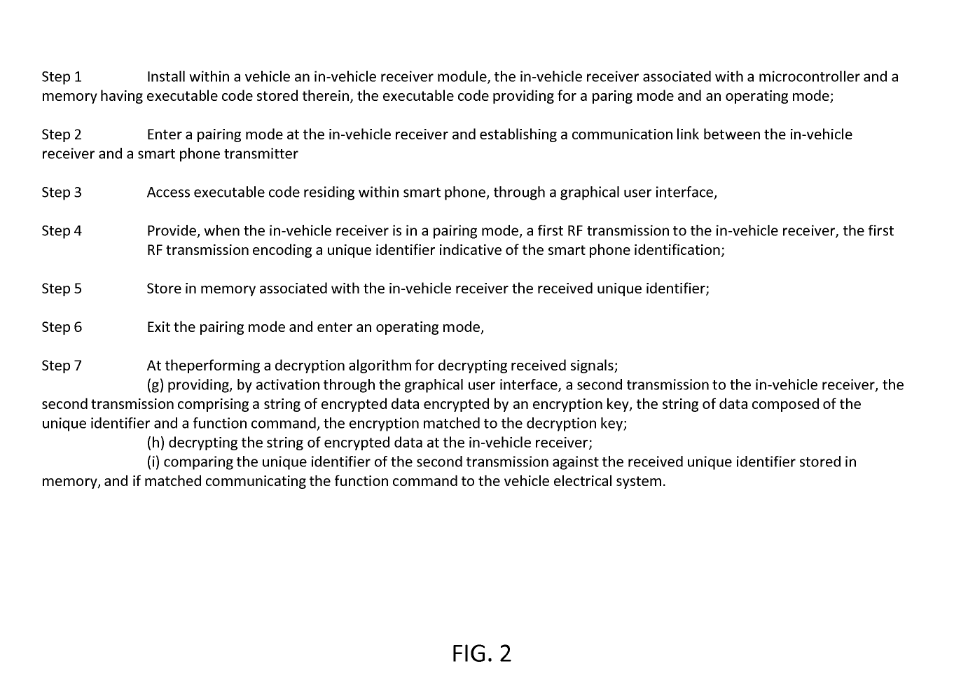

Now referring to FIG. 1 in conjunction with FIG. 2, described is the inventive method. At Step 1, the receiver module is install within a vehicle. As discussed above, the receiver module 31 includes a microcontroller 40 and a memory 50 having executable code stored therein. The executable code provides for selecting between a paring mode and an operating mode. At Step 2 the receiver module 31 is placed in the pairing mode whereby an smart phone identifier may be received. To place the module 31 in the pairing mode, a switch 93 is depressed. At Step 3 an application having a graphical user interface on the smart phone 100 is accessed. Touching a pairing icon 111 establishes a communication link between the receiver module and smart phone. At Step 4, the smart phone provides a first RF transmission which is received at the receiver module, the first RF transmission encodes smart phone identifier which can be the smart phone manufacture identification number (MIN) or service identification number (SIM) or an identification number generated by the app. At Step 5 the identification is store in the receiver module memory. At Step 6 the module exits the pairing mode and enter an operating mode. When in the operating mode received signals are decrypted by a decryption key. At Step 8 the smart phone 100 generates, by activation through the graphical user interface icon 110, a second transmission that is transmitted to the receiver module 31. The second transmission is comprised of a string of encrypted data, encrypted by an encryption key residing within the smart phone application. The string of encrypted data is composed of the smart phone identifier and a function command. In some embodiments, the string may also include a passive anti-theft system transponder code. At Step 9 the string of encrypted data is decrypting the at the in-vehicle receiver using the matching encryption key. At Step 10 the smart phone identifier of the second transmission is compared against the previously received unique identifier that was stored in memory 50, and if they match the function command is communicated to the vehicle electrical system for execution.

Through this method, authentication of the remote start or function control command signal is confirmed at multiple layers in the communication links from the smart phone to the vehicle's engine start system. If authentication is not confirmed at each layer, the start command is denied and the vehicle cannot be remotely started.

While the foregoing written description of the invention enables one of ordinary skill to make and use the invention, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The present invention thus can be embodied in other specific forms without departing from its spirit or essential characteristics. The described embodiment is to be considered in all respects only as illustrative and not restrictive. The scope of the invention is, therefore, indicated by the appended claims rather than by the foregoing description.

1. A method for authenticating a command signal of a remote function control system that controls vehicle door locks and engine starting, the command signal issued from a smart phone transmitter without transmission through a cellular network and received by an in-vehicle receiver associated with the vehicle electrical system, the method comprising the steps of:
(a) installing within a vehicle the in-vehicle receiver, the in-vehicle receiver associated with a microcontroller and a memory having executable code stored therein, the executable code providing for a paring mode and an operating mode;
(b) entering the pairing mode at the in-vehicle receiver for establishing a communication link between the in-vehicle receiver and the smart phone transmitter;
(c) accessing executable code residing within smart phone, the executable code having a graphical user interface,
(d) transmitting when the in-vehicle receiver is in a pairing mode, by activation through the graphical user interface, a first transmission to the in-vehicle receiver, the first transmission encoding a signal, the signal having a unique identifier component indicative of the smart phone identification;
(e) storing in the memory associated with the in-vehicle receiver the received unique identifier;
(f) exiting the pairing mode at the in-vehicle receiver and automatically entering an operating mode, whereby when in an operating mode, and when in the operating mode performing a decryption algorithm for decrypting received signals;
(g) transmitting, by activation through the graphical user interface, a second transmission to the in-vehicle receiver, the second transmission comprising a string of encrypted data encrypted by the selected encryption key, the string of data composed of the unique identifier and a function command;
(h) decrypting the string of encrypted data at the in-vehicle receiver;
(i) comparing the unique identifier of the second transmission against the received unique identifier stored in memory, and if matched communicating the function command to the vehicle electrical system.

2. The method of claim 1 wherein step (c) further comprises the step of:
selecting an encryption key from a plurality of encryption keys.

3. The method of claim 2 wherein step (e) further comprises the step of:
storing the selected encryption key.

4. A method for authenticating a command signal of a remote function control system that controls vehicle door locks and engine starting, the command signal issued from a smart phone transmitter without transmission through a cellular network and received by an in-vehicle receiver associated with the vehicle electrical system, the method comprising the steps of:
(a) installing within a vehicle the in-vehicle receiver, the in-vehicle receiver associated with a microcontroller and a memory having executable code stored therein, the executable code providing for a paring mode and an operating mode;
(b) entering the pairing mode at the in-vehicle receiver for establishing a communication link between the in-vehicle receiver and the smart phone transmitter;
(c) accessing executable code residing within smart phone, the executable code having a graphical user interface, and selecting an encryption key from a plurality of encryption keys;
(d) providing when the in-vehicle receiver is in a pairing mode, by activation through the graphical user interface, a first transmission received at the in-vehicle receiver, the first transmission encoding a signal indicative of the selected encryption key, the signal having a unique identifier component indicative of the smart phone identification;
(e) storing in the memory associated with the in-vehicle receiver the received selective encryption key and unique identifier;
(f) exiting the pairing mode at the in-vehicle receiver and automatically entering an operating mode, whereby when in an operating mode performing a decryption algorithm for decrypting received signals;
(g) providing, by activation through the graphical user interface, a second transmission to the in-vehicle receiver, the second transmission comprising a string of encrypted data encrypted by an encryption key, the string of data composed of the unique identifier and a function command, the encryption matched to the decryption key;
(h) decrypting the string of encrypted data at the in-vehicle receiver;
(i) comparing the unique identifier of the second transmission against the received unique identifier stored in memory, and if matched communicating the function command to the vehicle electrical system.
